(19) United States
(12) Patent Application Publication
(10) Pub. No.: US 2012/0048126 A1
(43) Pub. Date: Mar. 1, 2012

(54) COOKING UTENSIL

(76) Inventor: Graham Tweed, Saharn Toney (GB)

(21) Appl. No.: 13/145,020

(22) PCT Filed: Jan. 19, 2010
(86) PCT No.: PCT/GB10/50073

§ 371 Date: Sep. 21, 2011

(30) Foreign Application Priority Data
Jan. 19, 2009 (GB) 0900799.8
May 18, 2009 (GB) 090849.30

(51) Int. Cl. A47J 43/16

(52) U.S. Cl. 99/494

(57) ABSTRACT

A cooking utensil which comprises a container from one region of which there projects a handle and which is constructed and intended to resist the heat generated around the container when the container is filled with herbs, spices, stuffing or the like and the utensil is inserted, container foremost and handle rearmost, into the inside of e.g. a bird such as a turkey which is then place in an oven to be cooked; the container being perforated so that, in use, juices generated within it will infuse into the bird; and the construction and material of the utensil being such that as it heats up, it releases its heat into the bird's inside as and/or after the bird cooks.

### FIELD OF THE INVENTION

The invention relates to cooking utensils and is concerned specifically with means to improve the cooking of e.g. a bird, such as a turkey, which is habitually filled with herbs, spices, stuffing or the like and then placed in an oven to be cooked.

The Problem Encountered

Research and experience have cumulatively dictated that it is now, potentially, not wholly safe to stuff turkeys and the like and then simply place them in an oven to be slow-cooked. This is especially so if, for whatever reason, the giblets are included in the stuffing. But it is of more conventional forms of stuffing including sausage meat, especially if the sausage meat or other components have been stored separately from the turkey itself for any appreciable time and in what could well be differing storage conditions as well as different storage times and sources of origin of which limited information is available.

One way round this problem is to cook the turkey and its would-be contents separately. But then there is no chance for the flavours generated by the two separated cookings to mingle during cooking. They can be mixed in subsequent consumption but the effect will not be the same.

Another obvious solution is to cook and eat only the bird itself without any of the traditional flavourings. But whilst this avoids any cross-contamination risk during cooking, eating poultry without flavourings is at best a bland taste experience however well the bird is cooked.

### SUMMARY OF THE INVENTION

In order to overcome this problem the invention provides, in its broadest aspect, a cooking utensil which comprises a container from one region of which there projects a handle and which is constructed and intended to resist the heat generated around the container when the container is filled with herbs, spices, stuffing or the like and the utensil is inserted, container foremost and handle rearmost, into the inside of e.g. a bird such as a turkey which is then place in an oven to be cooked; the container being perforated so that, in use, juices generated within it will infuse into the bird.

Such a utensil effectively separates the added flavouring components from the inside of the bird itself, and whilst allowing the flavouring juices generated to mingle agreeably during cooking with the bird's flesh, minimises if not eliminates altogether the cross-contamination risk.

In a development of this broad aspect the invention provides a preferred construction in which, within the broadest aspect of the invention outlined above, that portion of the container which, in use, contains the herbs etc is openable and closeable.

Whilst it is within the scope of the invention for the container and its flavouring contents to be pre-manufactured as a one-use-only item, a re-useable item which can be repeatably filled, used, cleaned out and washed, and then used again is clearly preferable for practical purposes.

Preferably also, in the case just outlined, one portion of the openable and closeable portions screw-fits and/or push-fits onto the other. Conventional oven-proof pots have lids which simply sit and are located in place on the main body of the container. But it is much better, within the intent of the invention, to have a positive push and/or screw fit to prevent the container contents being dislodged inadvertently, even during, for example, what might well be a forced insertion into the bird.

More preferably, the openable and closeable portions mate around a periphery of the container and the plane of said periphery is angled with respect to the plane of that region of the handle which adjoins the container. The positioning of the handle in relation to the openable and closeable portions provides improved the handling of the two portions while being scewed and/or pushed together and also during their subsequent separation.

Preferably, said openable and closeable portions are attached to each other via a hinge means. The hinge provides a quick and easy closure of the utensil to form a container, which retains its contents by compressing between the openable and closeable portions.

Preferably, said handle projects from said openable portion and said closeable portion further comprises a second handle which projects from said closeable portion which, in use, both said handles close adjacently together to form a substantial handle. The two handles provide leverage for compressing the contents of the utensil between the openable and closeable portions. Furthermore, the handles provide an improved means of handing the utensil, which ensures that it is encloses its contents, once it has been closed to form a container.

More preferably, each said handle further comprises an aperture that is aligned with an aperture within said second handle which, in use, facilitate the hanging of the utensil when the handles are closed adjacently together. The apertures enable the utensil, when not in use, to be hung from a cooking utensil storage device.

Preferably, said hinge means is located on said openable and closeable portions on the opposed side in relation to said projecting handles to facilitate the opening and closing of the cooking utensil in a substantially clam-shell configuration. The openable and closeable portions open and close about its contents in a manner similar to a clam-shell.

Preferably, said openable and closeable portions further are attached to each other about their peripheral edges by a snap-fitting means. The snap-fitting means provides a quick and easy closure of the utensil to form a container, which retains its contents by compressing between the openable and closeable portions as they are pushed and interlocked together.

Preferably, further comprises a flat portion within its outer surface which, in use, facilitates the utensil to sit flat. The flat portion of the outer surface enables the utensil to sit flat inside the bird as it cooks.

A utensil according to any preceding claim and in which the construction and material of the utensil is such that as it heats up, it releases its heat into the bird's inside as and/or after the bird cooks. The material of which the utensil is made, in particular its container portion, is advantageously such that it heats up and releases its heat into the bird's inside as and/or after the bird cooks in the oven. Whilst it need not be so within the broadest aspect of the invention, in this preferred embodiment it has the dual advantageous effect of effectively cooking the bird from within as and/or after the juices released by its contents released into the bird's inside.

A utensil according to any of the preceding claims and in which each said perforation further comprises a bevelled outer edge for facilitating the migration of juices generated by the cooking of the bird. The bevelled edges facilitate the flow of juices generated within the utensil, from the utensil into the bird matter surrounding the utensil.

The invention includes within its scope a cooking utensil substantially as described herein with reference to and as illustrated in any appropriate combination of the accompanying text and/or drawings.

### BRIEF DESCRIPTION OF THE DRAWINGS

FIG. 1 shows a front perspective view of a utensil in the preferred embodiment of the invention.

FIG. 2 shows a rear perspective view of the utensil in the preferred embodiment of the invention, wherein the openable and closeable portions of the invention are hinged together to form a clam-shell container.

FIG. 3 shows a perspective view of the utensil in an alternative embodiment of the invention, wherein the openable and closeable portions of the invention are screwed together to form an ovoid container.

FIG. 4 shows an alternative embodiment of the invention inserted into a bird.

FIG. 5 shows a perspective view of the utensil in another alternative embodiment of the invention, wherein the openable and closeable portions of the invention are snap-fitted together to form a container.

FIG. 6(a) shows a cross sectional view of the snap fitting means shown in FIG. 5 in an uncoupled configuration.

FIG. 6(b) shows a cross sectional view of the snap fitting means shown in FIG. 5 in a coupled configuration.

### DESCRIPTION OF THE PREFERRED EMBODIMENT

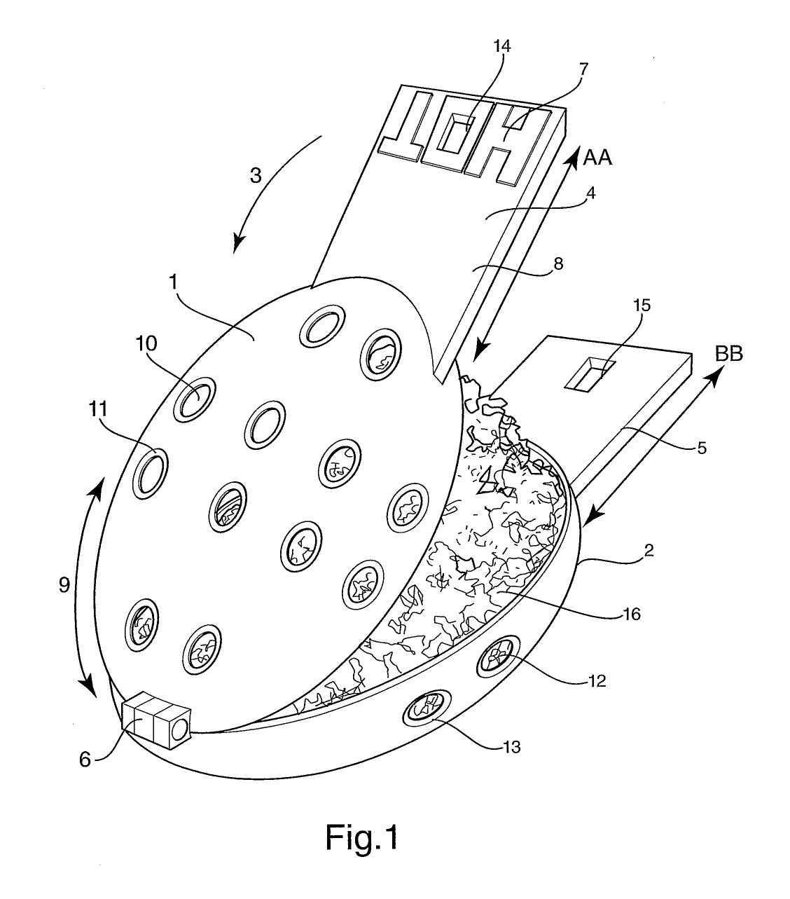

FIG. 1 shows the preferred embodiment of the invention, in which a cooking utensil comprising essentially two body portions 1 and 2, a container generally referenced by 3 and two handles 4 and 5. Handle portion 4 extends from body portion 1 at right angle to the horizontal axis AA of the body portion 1, which is itself semi ovoid. Handle portion 5 extends from body portion 2 at right angle to the horizontal axis BB of the body portion 2, which is also semi ovoid. Body portion 2 incorporates a centrally located flat portion (not shown) to enable the utensil to sit flat and prevent it from rolling. The two body portions 1 and 2 are rotatably joined together by an integral hinge 6. The hinge 6 and handles 4 and 5 shown, are made from the same material, typically cast iron, as body portions 1 and 2, however it need not necessarily be so. Handles 4 and 5 are shown to incorporate a taper that reduces in width towards body portions 1 and 2. Handle 4 incorporates a graphical illustration “HOT” 7 upon its upper surface 8. Handle 4 incorporates a substantially rectangular aperture 14 within the centre of “O” in the illustration “HOT”. Aperture 14 is aligned with aperture 15 disposed substantially towards the end of handle 5, when body members 1 and 2 are closed together.

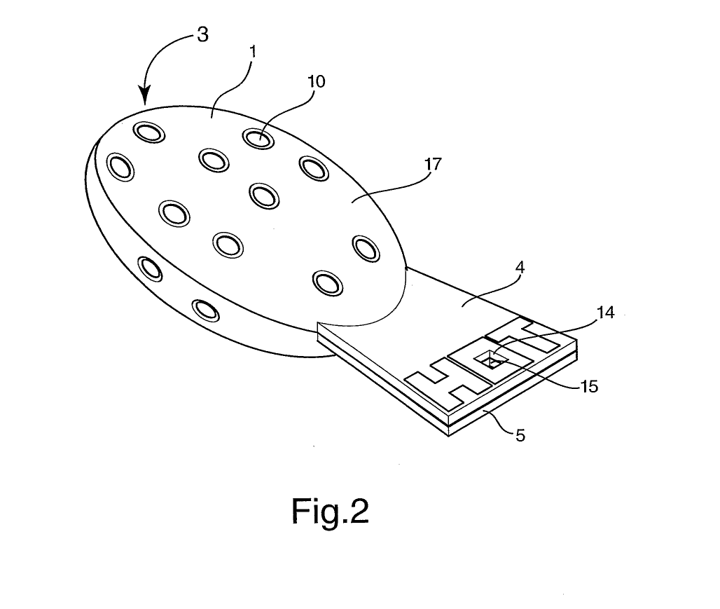

The cast iron container 3 is openable and closeable in the directions indicated by arrows 9. Hinge 6 is disposed on the outer surfaces of two body portions 1 and 2, opposite respective handles 4 and 5. Body portion 1 incorporates an array of equally spaced perforations 10, arranged in linear lines that traverse body portion 1. Each perforation 10 is substantially an oval aperture in shape and incorporates a uniformly thick, bevelled outer edge 11. Body portion 2 also incorporates an array of equally spaced perforations 12 (partially shown), arranged in linear lines that traverse body portion 2. Each perforation is substantially oval in shape and incorporates a uniformly thick, bevelled outer edge 13. The bevelled outer edges 11 and 13 promote the migration of juices generated by the cooking of the container's contents to infuse into whatever surrounds the container 3. When body portions 1 and 2 are closed, the container 3 takes the general shape of a notional fish (as shown in FIG. 2).

The external surface of the cooking utensil will be finished appropriately for example by so-called stove enamelling. In an alternative embodiment of the invention the cooking utensil is coated with a non-stick material, which prevents its outer surface from being permanently marked from any burning, or by matter from the bird itself. The non stick coating also enables the cooking utensil to be easily cleaned after use.

In use, body members 1 and 2 close together in a “clam-shell” like fashion to form container 3, which is loaded with herbs and spices, stuffing or the like. The contents 16 of the container are compressed into position by the closing of body member 1 against body member 2. Once the container 3 has been filled, it is then inserted into the bird and then both the bird and the container 3 are inserted into an oven, to be cooked. Handles 4 and 5 protrude from the bird and as the bird cooks in the oven, heat from the oven is transmitted into the container 3, via the handles 4 and 5. The cast iron material used to manufacture the cooking utensil enables efficient heat transmission from the oven into the container 3.

FIG. 2 shows an upper rear perspective view of the preferred embodiment of the invention. The body member 1 is shown to incorporate an array of oval perforations 10 as shown in FIG. 1. The closed container, generally referenced by 3, gives the appearance of a notional fish-like configuration 17. Handles 4 and 5 are shown to be closed and adjacent to each other. Apertures 14 and 15 are shown in alignment with each other to enable the utensil to be hung, when not in use. The closed cooking utility is shaped so that it fits snugly within the cavity of the bird.

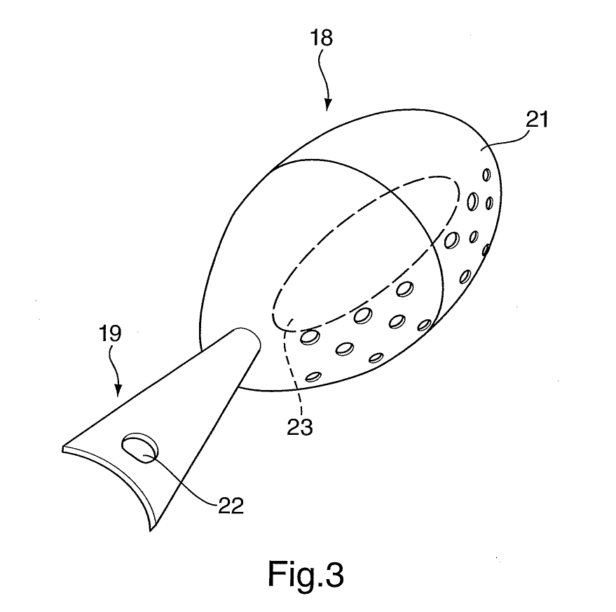

FIG. 3 shows an alternative embodiment of the invention in which the cooking utensil forms a container and is generally referenced by 18. The handle 19 extends from the container portion 20 at right angle to the axis of the container portion 20 which is itself ovoid. The two are rigidly joined and, whilst the handle 19 in this particular embodiment is made of the same material—cast iron—as the container 20, it need not necessarily be so.

The cast iron container 18 is separable into two equal halves respectively 20 and 21 in the drawing. Each half is perforated as shown. They twist-and-push together to form an openable and closeable seal for any contents whilst allowing juices generated by the cooking of those contents to infuse into whatever surrounds the container.

The handle 19 is elongate, substantially flat, and has the general shape of a notional fish tail. A through-hole 22 at its projecting extremity enables the whole utensil to be hung when not in use.

A designated bottom region 23 of the container is flattened so that when the container and any contents are inserted into, for example, a turkey, then the utensil will sit flat as the turkey cooks with the utensil inside it. In practical embodiments the whole of the external surface of the utensil will be finished appropriately for example by so-called stove enamelling in, say, deep green colour so as to blend with its intended area of kitchen usage.

In actual use, the container is loaded with herbs, spices, stuffing or the like and, once having been closed over those contents, is inserted, container foremost, handle rearmost, into the inside of the bird with the flattened bottom portion 23 of the container lowermost. The bird is then placed in an oven to be cooked. As the bird cooks in the oven, the container heats up, and gives up its heat simultaneously to the stuffing etc inside it and to the inside of the bird itself.

Simultaneously therefore the juices generated within the container infuse into the bird's inside and the bird is cooked from within by the container as well as from without by the oven.

When the bird is judged to be fully cooked, and removed from the oven to cool, or to be served relatively quickly thereafter, the infusion and the cooking-from-inside processes will continue as the hot container continues to give up its heat to its own contents and to the bird's inside. The best possible combination of flavouring and ensuring the bird is fully cooked through is therefore obtained.

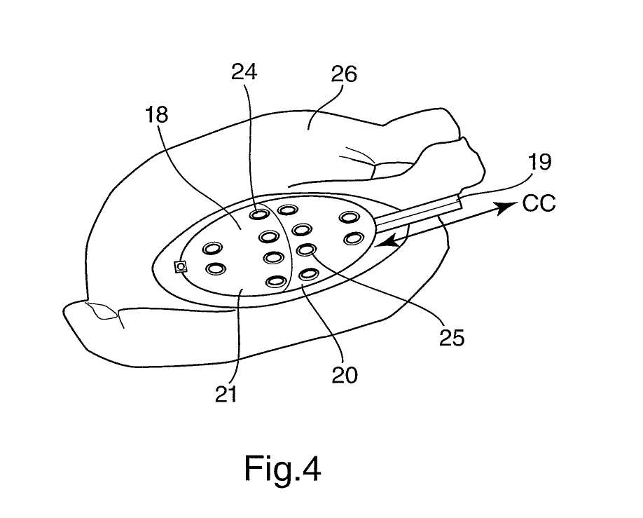

FIG. 4 shows the alternative embodiment of the invention as, described in FIG. 3, inserted into a bird. The two body members 20 and 21 are screwed together to form a “bulb-like” container 18. Each body member 20 and 21 incorporates an array of oval perforation 24 and 25 similar to those shown in FIGS. 1 to 3. Handle 19 extends from body member 20 at right angle to the horizontal axis CC of the body portion 20, which is itself semi ovoid. The protrusion of the handle 19 from the bird 26 enables heat from the oven to be transmitted into the bird itself, via the body members 20 and 21. The cooking utensil provides the advantage of reducing the cooking time required for the bird, for example the cooking time maybe reduced by twenty minutes. However, this depends upon the size of the bird.

A cooking utensil as illustrated comprises a container from one region of which there projects a handle and which is constructed and intended to resist the heat generated around the container when the container is filled with herbs, spices, stuffing or the like and the utensil is inserted, container foremost and handle rearmost, into the inside of e.g. a bird such as a turkey which is then place in an oven to be cooked; the container being perforated so that, in use, juices generated within it will infuse into the bird. Such a utensil is characterised in that that portion of the container which, in use, contains the herbs etc is openable and closeable. The illustrated utensil may be one in which the openable and closeable portions are joined by a hinge, as illustrated in FIGS. 1 and 2.

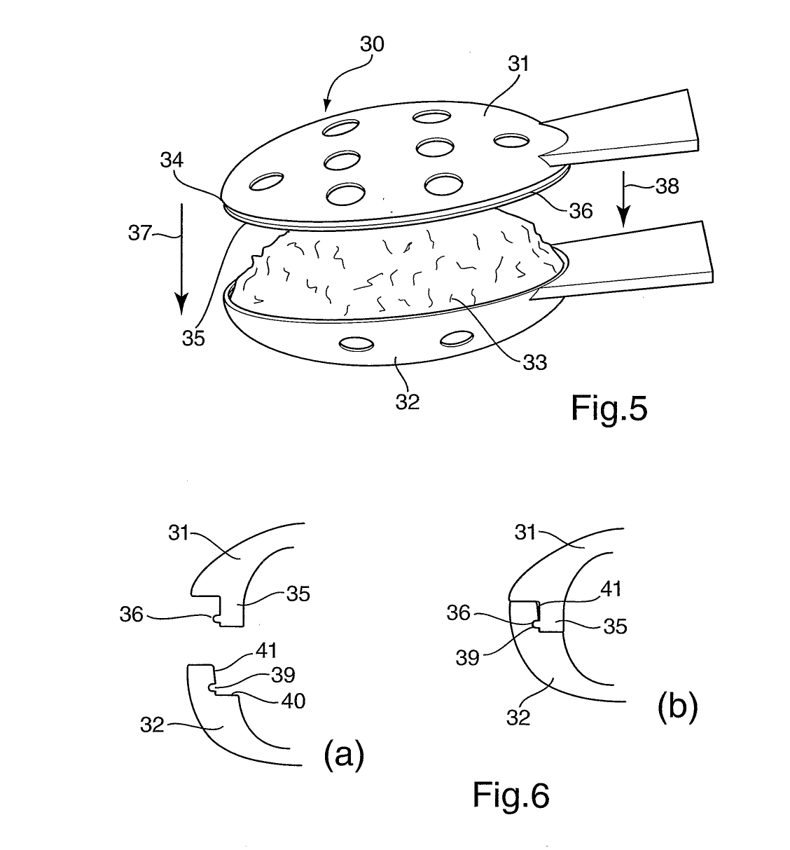

FIG. 5 shows an alternative embodiment of the invention in which the cooking utensil comprises essentially body two portions 31 and 32, which form a container generally referenced by 30. The overall shape of the two body members 31 and 32 gives the appearance of a notional fish-like configuration as in FIG. 2. The lower body portion 32 contains a quantity of stuffing or the like 33. The upper body portion 31 incorporates a downward projecting annular flange 35, which extends around its peripheral edge 34. The projecting flange 35 incorporates an annular tongue 36 which extends around the outer facing surface of the flange 35. The tongue locates within an annular groove (shown in FIGS. 6(a) and (b)) which extends about the inner surface of body portion 32.

In use, the upper body portion 31 is lowered on to lower body portion 32 in the direction indicated by arrows 37 and 38. The downward projecting annular flange 35 locates within the peripheral edge of lower body portion 32, which enables the annular tongue 36 to cooperate and locate with the annular groove. Therefore, providing a snap-fitting means, this fastens the upper body portion 31 to the lower body portion 32 which forms the container 30 for enclosing the stuffing or the like.

FIG. 6(a) shows a cross sectional view of the upper body portion 31 aligned with the lower body portion 32 in an uncoupled configuration. The annular tongue 36 and annular groove 39 which when engaged form the snap-fitting means are clearly shown. Also, the lower body portion 32 incorporates a annular recess 40 about its inner peripheral edge for accommodating the downward projecting annular flange 35 of the upper body portion 31. The annular recess 40 incorporates a slight vertical gradient within its vertical, inner facing wall, which is inclined towards the annular groove 39. The gradient facilitates the cooperation and engagement of the annular tongue 36 within the annular groove 39.

FIG. 6(b) shows a cross sectional view of the upper body portion 31 aligned with the lower body portion 32 in a coupled configuration. The annular tongue is shown to be located within the annular groove 39, therefore forming the snap-fitting means. Also, the downward projecting annular flange 35 of the upper body portion 31 is shown to be engaged within the annular recess of the lower body portion 32. The vertical gradient of the inner wall 41 of the lower body portion is clearly shown.

1-13. (canceled)

14. A cooking utensil which comprises a container from one region of which there projects a handle and which is constructed and intended to resist the heat generated around the container when the container is filled with herbs, spices, stuffing or the like and the utensil is inserted, container foremost and handle rearmost, into the inside of e.g. a bird such as a turkey, which is then placed in an oven to be cooked; the container being perforated so that, in use, juices generated within it will infuse into the bird.

15. A utensil according to claim 14 and characterised in that that portion of the container which, in use, contains the herbs etc is openable and closeable.

16. A utensil according to claim 15 and which the openable and closeable portions are a screw fit and/or push fit one on the other.

17. A utensil according to claim 16 and in which the openable and closeable portions mate around a periphery of the container and the plane of said periphery is angled with respect to the plane of that region of the handle which adjoins the container.

18. A utensil according to claim 15, in which said openable and closeable portions are attached to each other via a hinge means.

19. A utensil according to claim 18 and in which said handle projects from said openable portion and said closeable portion further comprises a second handle which projects from said closeable portion which, in use, both said handles close adjacently together to form a substantial handle.

20. A utensil according to claim 19 and in which each said handle further comprises an aperture that is aligned with an aperture within said second handle which, in use, facilitate the hanging of the utensil when the handles are closed adjacently together.

21. A utensil according to claim 18 and in which said hinge means is located on said openable and closeable portions on the opposed side in relation to said projecting handles to facilitate the opening and closing of the cooking utensil in a substantially clam-shell configuration.

22. A cooking utensil according to claim 15 in which said openable and closeable portions further are attached to each other about their peripheral edges by a snap-fitting means.

23. A utensil according to claim 14 and in which further comprises a flat portion within its outer surface which, in use, facilitates the utensil to sit on a flat surface.

24. A utensil according to claim 14 and in which the construction and material of the utensil is such that as it heats up, it releases its heat into the bird's inside as and/or after the bird cooks.

25. A utensil according to claim 14 and in which each said perforation further comprises a bevelled outer edge for facilitating the migration of juices generated by the cooking of the bird.
